(19) United States
(12) Patent Application Publication
(10) Pub. No.: US 2024/0337490 A1
(43) Pub. Date: Oct. 10, 2024

(54) DUAL-AXIS GYROSCOPE AND ELECTRONIC DEVICE

(71) Applicant: AAC Kaitai Technologies (Wuhan) CO., LTD, Wuhan (CN)

(72) Inventors: Shan Yang, Wuhan (CN); Xiao Kan, Wuhan (CN); Zhan Zhan, Wuhan (CN); Shitao Yan, Wuhan (CN); Zhao Ma, Wuhan (CN); Hongtao Peng, Wuhan (CN); Yang Li, Wuhan (CN); Veronica Tan, Singapore (SG); Kahkeen Lai, Singapore (SG); Zaixiang Pua, Singapore (SG); Houming Chong, Johor (MY)

(21) Appl. No.: 18/401,223

(22) Filed: Dec. 29, 2023

Related U.S. Application Data
(63) Continuation of application No. PCT/CN2023/096266, filed on May 25, 2023.

(30) Foreign Application Priority Data
Apr. 4, 2023 (CN) 202310354638.4

(51) Int. Cl. G01C 19/5705

(52) U.S. Cl. CPC G01C 19/5705

(57) ABSTRACT

The present invention provides a dual-axis gyroscope and an electronic device. The dual-axis gyroscope comprises first mass blocks, second mass blocks, a driving unit and a detecting unit. Tightly coupled connections are formed between adjacent first mass blocks, and between adjacent second mass blocks, thus improving the accuracy of displacement ratios of the first mass blocks and the second mass blocks, and enhancing the operational accuracy and stability of the dual-axis gyroscope. Furthermore, the requirement for the machining precision of the first mass blocks and the second mass blocks is reduced, thus lowering the manufacturing cost of the dual-axis gyroscope and the electronic device.

### TECHNICAL FIELD

The present invention relates to the technical field of gyroscopes, in particular to a dual-axis gyroscope and an electronic device.

### BACKGROUND

A dual-axis gyroscope is a typical angular rate microsensor that can detect the angular rates of an electronic device rotating around first and second axes, and has extensive applications in the electronics market due to its small size, low power consumption, and convenient processing.

A dual-axis gyroscope in the related art comprises a plurality of first mass blocks and a plurality of second mass blocks. The first mass blocks are used for detecting the angular rate of the electronic device rotating around the first axis, and the second mass blocks are used for detecting the angular rate of the electronic device rotating around the second axis. Weakly coupled connections are formed between adjacent first mass blocks and adjacent second mass blocks. That is, in the process of detecting angular rates with the dual-axis gyroscope, there are significant differences in motion parameters such as the moving distance and rotation angle between the plurality of first mass blocks, as well as between the plurality of second mass blocks, which affects the detection precision, accuracy, and reliability of the gyroscope.

Therefore, it is necessary to provide a dual-axis gyroscope with small differences in motion parameters between mass blocks.

### SUMMARY

The present invention aims to provide a dual-axis gyroscope with small differences in motion parameters between mass blocks.

The technical solutions of the present invention are as follows.

A first aspect of the present invention provides a dual-axis gyroscope, comprising:
first mass blocks each capable of swinging around a first anchor point in a first plane and swinging around a first central axis of the first anchor point;
second mass blocks each capable of swinging around a second anchor point in the first plane and swinging around a second central axis of the second anchor point;
wherein a plane in defined by a length direction and a width direction of the dual-axis gyroscope is the first plane, the first central axis and the second central axis are both located in the first plane, and one of the first central axis and the second central axis is parallel to the length direction of the dual-axis gyroscope and the other is parallel to the width direction of the dual-axis gyroscope;
the first mass blocks and the second mass blocks are distributed in a first direction, the plurality of first mass blocks are distributed in a second direction, swing directions of adjacent first mass blocks are opposite, the plurality of second mass blocks are distributed in the second direction, swing directions of adjacent second mass blocks are opposite, and one of the first direction and the second direction is the length direction of the dual-axis gyroscope and the other is the width direction of the dual-axis gyroscope; and
tightly coupled connections are formed between adjacent first mass blocks through first coupling rods, and tightly coupled connections are formed between adjacent second mass blocks through second coupling rods;
a driving unit connected with the first mass blocks and the second mass blocks to drive the first mass blocks and the second mass blocks to swing in the first plane; and
a detecting unit capable of detecting a swing angle of the first mass block around the first central axis and a swing angle of the second mass block around the second central axis.

In some embodiments, the first coupling rod comprises a first connecting portion, a second connecting portion and a third connecting portion, and the first connecting portion and the second connecting portion are oppositely arranged on two sides of the third connecting portion in the first direction; and at least part of the first connecting portion and at least part of the second connecting portion extend in the second direction, and the first connecting portion and the second connecting portion are connected to adjacent first mass blocks.

In some embodiments, the second coupling rod comprises a fourth connecting portion, a fifth connecting portion and a sixth connecting portion, and the fourth connecting portion and the fifth connecting portion are oppositely arranged on two sides of the sixth connecting portion in the first direction; and at least part of the fourth connecting portion and at least part of the fifth connecting portion extend in the second direction, and the fourth connecting portion and the fifth connecting portion are connected to adjacent second mass blocks.

In some embodiments, the driving unit comprises driving parts, driving decoupling structures and coupling beams, the driving parts are fixedly connected with the driving decoupling structures, the driving decoupling structures and the first mass blocks are connected through the coupling beams, and the driving decoupling structures and the second mass blocks are connected through the coupling beams; and the driving parts are capable of driving the driving decoupling structures to move in the second direction to drive the first mass blocks and the second mass blocks to swing in the first plane.

In some embodiments, the plurality of driving decoupling structures are distributed in the first direction, the first mass blocks are located between adjacent driving decoupling structures, the second mass blocks are located between adjacent driving decoupling structures, and the first mass blocks and the second mass blocks are connected through the coupling beams and the driving decoupling structures.

In some embodiments, the driving part comprises a capacitive driving structure and/or an inductive driving structure.

In some embodiments, at least part of the coupling beam is a deformable structure, and at least part of the coupling beam is elastically deformable when the first mass block swings around the first central axis and the second mass block swings around the second central axis.

In some embodiments, the dual-axis gyroscope further comprises torsion beams, the first mass blocks and the first anchor points are connected through the torsion beams, and the second mass blocks and the second anchor points are connected through the torsion beams; and

when the first mass block and the second mass block swing, at least part of the torsion beam is elastically deformable.

In some embodiments, the detecting unit comprises a differential detection structure, and the differential detection structure comprises a differential capacitor and/or a differential inductor.

A second aspect of the present invention provides an electronic product, which comprises:
a body; and
the dual-axis gyroscope as described above, wherein the dual-axis gyroscope is mounted on the body.

The beneficial effects of the present invention are as follows. The tightly coupled connections between the first mass blocks and the tightly coupled connections between the second mass blocks of the dual-axis gyroscope reduce rotation angle errors between the first mass blocks and rotation angle errors between the second mass blocks during operation, thereby improving the accuracy of displacement ratios of the first mass blocks and the second mass blocks, and enhancing the operational accuracy and stability of the dual-axis gyroscope, and as a result, the operational stability of the electronic device is improved. Additionally, as the tightly coupled connections improve the accuracy of displacement ratios of the first mass blocks and the second mass blocks, the requirement for the machining precision of the first mass blocks and the second mass blocks is reduced, thus lowering the manufacturing cost of the dual-axis gyroscope and the electronic device. Moreover, frequency differences between a driving mode and a detection mode of the dual-axis gyroscope and its interference mode are increased, enhancing the anti-interference performance of the dual-axis gyroscope, thereby improving the operational stability and reliability of the dual-axis gyroscope. Further, in the detection mode of the dual-axis gyroscope, the motion of the first mass blocks and the motion of the second mass blocks are decoupled. That is, in a first detection mode, the first mass blocks swing, while there is no relative motion between the second mass blocks and the second anchor points. In a second detection mode, the second mass blocks swing, while there is no relative motion between the first mass blocks and the first anchor points. As a result, the cross-interference between angular rates in the first and second directions is reduced, minimizing the impact of orthogonal errors and improving the signal-to-noise ratio of a device.

### BRIEF DESCRIPTION OF DRAWINGS

FIG. 1 is a structural schematic diagram of a dual-axis gyroscope provided by the present invention in an embodiment;

FIG. 2 is a top view of FIG. 1, in which the dual-axis gyroscope is in a non-operating state;

FIG. 3 is a top view of FIG. 1, in which the dual-axis gyroscope is in a driving mode;

FIG. 4 is a structural schematic diagram of the dual-axis gyroscope in FIG. 1 in a first detection mode;

FIG. 5 is a structural schematic diagram of the dual-axis gyroscope in FIG. 1 in a second detection mode;

FIG. 6 is an enlarged view of part I in FIG. 2;

FIG. 7 is an enlarged view of part II in FIG. 2; and

FIG. 8 is an enlarged view of part III in FIG. 2.

List of reference numerals: 1—first moving component; 11—first mass block; 12—first anchor point; 13—first coupling rod; 131—first connecting portion; 132—second connecting portion; 133—third connecting portion; 14—first extension rod; 15—second extension rod; 16—third anchor point; 2—second moving component; 21—second mass block; 22—second anchor point; 23—second coupling rod; 231—fourth connecting portion; 232—fifth connecting portion; 233—sixth connecting portion; 3—driving unit; 31—driving part; 32—driving decoupling structure; 321—first driving decoupling structure; 322—second driving decoupling structure; 323—third driving decoupling structure; 33—coupling beam; 34—driving beam; 4—torsion beam; 5—fourth anchor point.

### DETAILED DESCRIPTION OF EMBODIMENTS

The present invention will be further described below with reference to the accompanying drawings and embodiments.

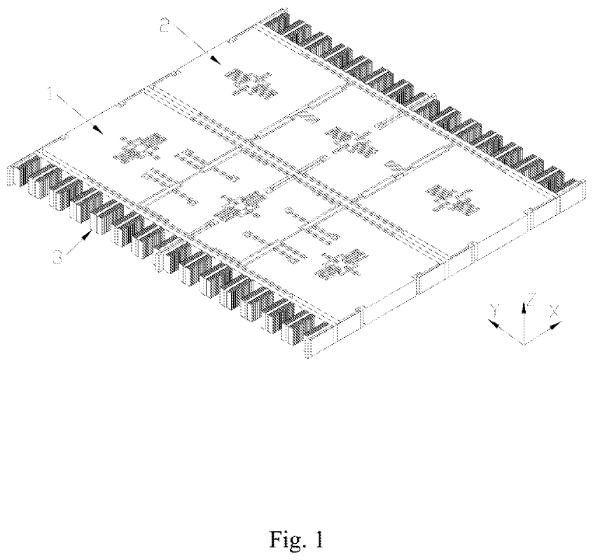

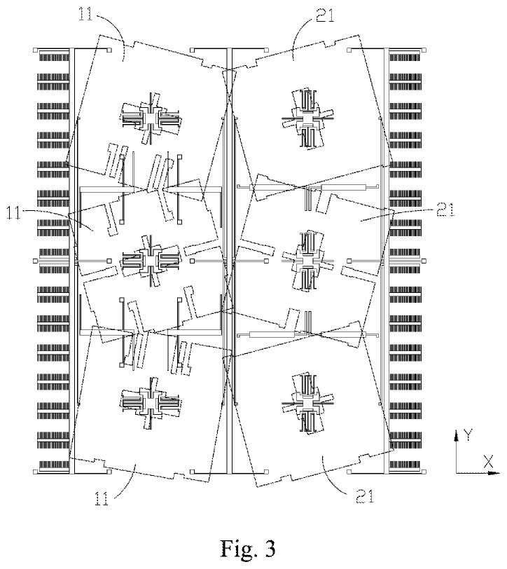

A first aspect of the present invention provides a dual-axis gyroscope. As shown in FIGS. 1-5, the dual-axis gyroscope comprises first moving components 1, second moving components 2, a driving unit 3 and a detecting unit (not labeled in the drawings). As shown in FIGS. 3, 4 and 5, the first moving component 1 comprises a first mass block 11 and a first anchor point 12, the first mass block 11 can swing around the first anchor point 12 in a first plane, and the first mass block 11 can swing around a first central axis of the first anchor point 12; and the second moving component 2 comprises a second mass block 21 and a second anchor point 22, the second mass block 21 can swing around the second anchor point 22 in the first plane, and the second mass block 21 can swing around a second central axis of the second anchor point 22. The driving unit 3 is connected with the first mass blocks 11 and the second mass blocks 21 to drive the first mass blocks 11 and the second mass blocks 21 to swing in the first plane. The detecting unit is used for detecting a swing angle of the first mass block 11 around the first central axis and a swing angle of the second mass block 21 around the second central axis, so as to detect external angular rates applied to the dual-axis gyroscope.

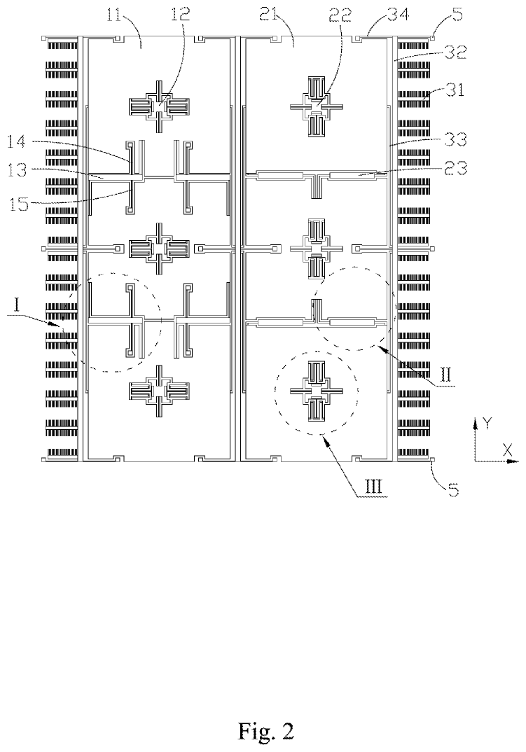

As shown in FIGS. 1 and 2, a plane defined by a length direction and a width direction of the dual-axis gyroscope is the first plane, the first central axis and the second central axis are both located in the first plane, and one of the first central axis and the second central axis is parallel to the length direction of the dual-axis gyroscope and the other is parallel to the width direction of the dual-axis gyroscope. For convenience of description, in the present invention, the width direction of the dual-axis gyroscope is a first direction X, the length direction of the dual-axis gyroscope is a second direction Y, a height direction of the dual-axis gyroscope is a third direction Z, the first central axis is parallel to the second direction Y, and the second central axis is parallel to the first direction X.

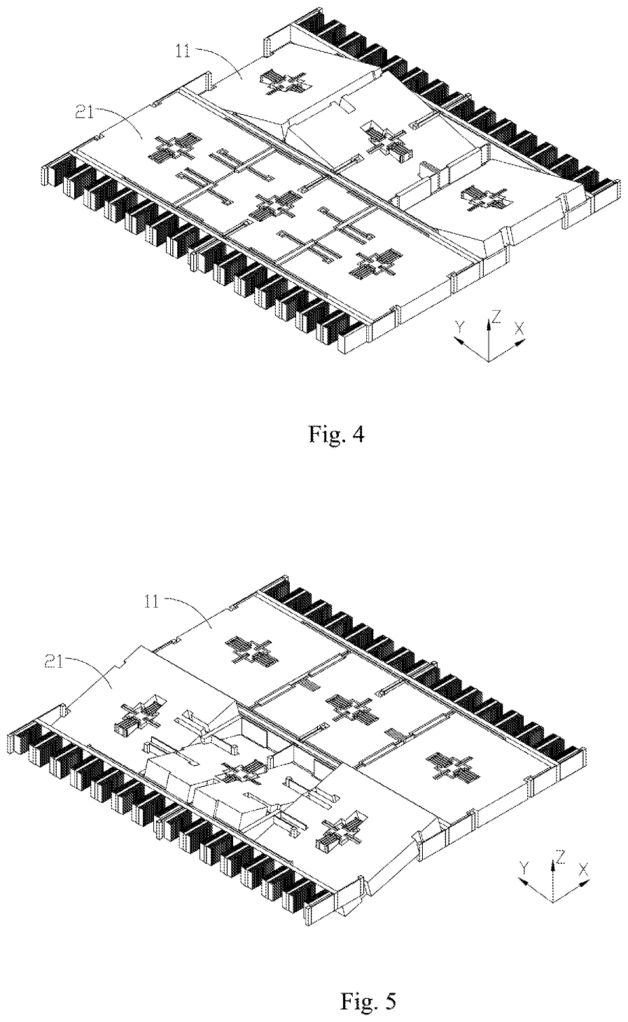

When not powered on, the dual-axis gyroscope is in a non-operating state as shown in FIGS. 1 and 2. When the dual-axis gyroscope is powered on, as shown in FIG. 3, the first mass block 11 and the second mass block 21 swing around the first anchor point 12 and the second anchor point 22 under the action of the driving unit 3. In this case, the dual-axis gyroscope is in a driving mode. When the dual-axis gyroscope is subjected to external angular rates, assuming that the dual-axis gyroscope is mounted on an electronic device, that is, when the electronic device rotates around the first direction X, as shown in FIG. 4, the first mass block 11 swings around the first central axis parallel to the second direction Y under a Coriolis force, switching the dual-axis gyroscope to a first detection mode. At this point, the detecting unit will detect a rotation angle of the first mass block 11 and transmit a detection result to a calculation system (not labeled in the figure), and the calculation system calculates the angular rate applied to the dual-axis gyroscope based on received data. When the electronic device rotates around the second direction Y, as shown in FIG. 5, the second mass block 21 swings around the second central axis parallel to the first direction X under a Coriolis force, switching the dual-axis gyroscope to a second detection mode. At this point, the detecting unit will detect a rotation angle of the second mass block 21 and transmit a detection result to the calculation system (not labeled in the figure), and the calculation system calculates the angular rate applied to the dual-axis gyroscope based on received data.

Specifically, as shown in FIGS. 1 and 2, the first moving components 1 and the second moving components 2 are distributed in the first direction X, the plurality of first moving components 1 are distributed in the second direction Y, and the plurality of second moving components 2 are distributed in the second direction Y, that is, the first mass blocks 11 and the second mass blocks 21 are distributed in the first direction X, the plurality of first mass blocks 11 are distributed in the second direction Y, swing directions of adjacent first mass blocks 11 are opposite, the plurality of second mass blocks 21 are distributed in the second direction Y, and swing directions of adjacent second mass blocks 21 are opposite. Tightly coupled connections are formed between adjacent first mass blocks 11 through first coupling rods 13, and tightly coupled connections are formed between adjacent second mass blocks 21 through second coupling rods 23.

In this embodiment, the tightly coupled connections between adjacent first mass blocks 11 through the first coupling rods 13 and the tightly coupled connections between adjacent second mass blocks 21 through the second coupling rods 23 reduce the risk of large swing angle errors between adjacent first mass blocks 11 and between adjacent second mass blocks 21, thereby improving displacement ratios between adjacent first mass blocks 11 and between adjacent second mass blocks 21. As a result, the accuracy of detecting the rotation angles of the first mass block 11 and the second mass block 21 is improved, which further improves the operational stability and accuracy of the dual-axis gyroscope.

Besides the driving mode and the detection mode, the dual-axis gyroscope also has an interference mode. The tightly coupled connections between adjacent first mass blocks 11 and the tightly coupled connections between adjacent second mass blocks 21 increase frequency differences between the driving mode and the detection mode of the dual-axis gyroscope and its interference mode, enhancing the anti-interference performance of the dual-axis gyroscope, thereby improving the operational stability and reliability of the dual-axis gyroscope.

Adjacent first mass blocks 11 are connected through the first coupling rods 13. As shown in FIG. 3, when one first mass block 11 rotates clockwise around the corresponding first anchor point 12, the adjacent first mass block 11 rotates counterclockwise around the corresponding first anchor point 12 under the traction of the corresponding first coupling rod 13. Similarly, adjacent second mass blocks 21 are connected through the second coupling rods 23. When one second mass block 21 rotates clockwise around the corresponding second anchor point 22, the adjacent second mass block 21 rotates counterclockwise around the corresponding second anchor point 22 under the traction of the corresponding second coupling rod 23. Therefore, by connecting adjacent first mass blocks 11 through the first coupling rods 13 and connecting adjacent second mass blocks 21 through the second coupling rods 23, adjacent first mass blocks 11 can move in opposite directions and adjacent second mass blocks 21 can move in opposite directions, and at the same time, the structures of the first motion component 1 and the second motion component 2 are simplified, thereby reducing the production cost of the dual-axis gyroscope.

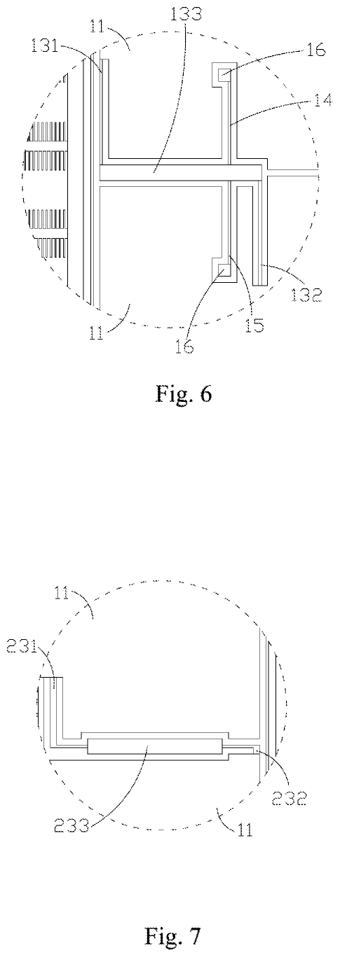

Specifically, as shown in FIGS. 2 and 6, the first coupling rod 13 comprises a first connecting portion 131, a second connecting portion 132 and a third connecting portion 133, and the first connecting portion 131 and the second connecting portion 132 are oppositely arranged on two sides of the third connecting portion 133 in the first direction X; and at least part of the first connecting portion 131 and at least part of the second connecting portion 132 extend in the second direction Y, and the first connecting portion 131 and the second connecting portion 132 are connected to adjacent first mass blocks 11.

In this embodiment, the first coupling rod 13 has a Z-shaped structure. When one end of the first coupling rod 13 is driven by the first mass block 11 to rotate clockwise, the other end of the first coupling rod 13 can drive the adjacent first mass block 11 to rotate counterclockwise, so as to realize swing of adjacent first mass blocks 11 in opposite directions. Therefore, the first coupling rod 13 is configured with the first connecting portion 131 extending in the second direction Y, the third connecting portion 133 extending in the first direction X, and the second connecting portion 132 extending in the second direction Y, simplifying the structure of the first coupling rod 13 and reducing the machining cost of the first coupling rod 13. In addition, the first coupling rod 13 can also have other deformation structures to increase the structural flexibility of the first coupling rod 13.

As shown in FIG. 6, the third connecting portion 133 is also connected with a first extension rod 14 and a second extension rod 15 which extend in the second direction Y. Extension directions of the first extension rod 14 and the second extension rod 15 are opposite, and the first extension rod 14 and the second extension rod 15 are respectively connected with third anchor points 16. In the first direction X, the first extension rod 14 and the second extension rod 15 are located between the first connecting portion 131 and the second connecting portion 132.

As shown in FIGS. 2 and 7, the second coupling rod 23 comprises a fourth connecting portion 231, a fifth connecting portion 232 and a sixth connecting portion 233, and the fourth connecting portion 231 and the fifth connecting portion 232 are oppositely arranged on two sides of the sixth connecting portion 233 in the first direction X; and at least part of the fourth connecting portion 231 and at least part of the fifth connecting portion 232 extend in the second direction Y, and the fourth connecting portion 231 and the fifth connecting portion 232 are connected to adjacent second mass blocks 21.

In this embodiment, the second coupling rod 23 has a Z-shaped structure. When one end of the second coupling rod 23 is driven by the second mass block 21 to rotate clockwise, the other end of the second coupling rod 23 can drive the adjacent second mass block 21 to rotate counterclockwise, so as to realize swing of adjacent second mass blocks 21 in opposite directions. Therefore, the second coupling rod 23 is configured with the fourth connecting portion 231 extending in the second direction Y, the fifth connecting portion 232 extending in the first direction X, and the sixth connecting portion 233 extending in the second direction Y, simplifying the structure of the second coupling rod 23 and reducing the machining cost of the second coupling rod 23. In addition, the second coupling rod 23 can also have other deformation structures to increase the structural flexibility of the second coupling rod 23.

The structure of the second coupling rod 23 is different from that of the first coupling rod 13 to distinguish the first detection mode from the second detection mode, thereby improving the reliability of detection results of the dual-axis gyroscope.

As shown in FIG. 2, the driving unit 3 comprises driving parts 31, driving decoupling structures 32 and coupling beams 33, the driving parts 31 are fixedly connected with the driving decoupling structures 32, the driving decoupling structures 32 and the first mass blocks 11 are connected through the coupling beams 33, and the driving decoupling structures 32 and the second mass blocks 21 are connected through the coupling beams 33; and the driving parts 31 are capable of driving the driving decoupling structures 32 to move in the second direction Y to drive the first mass blocks 11 and the second mass blocks 21 to swing in the first plane.

The driving part 31 comprises a capacitive driving structure and/or an inductive driving structure.

In this embodiment, the implementation of the driving part 31 includes, but is not limited to, the capacitive driving structure and the inductive driving structure, and the specific implementation of the driving part 31 is not particularly limited in this application, so as to increase the structural flexibility of the driving part 31 and further expand the application scope of the driving part 31.

Specifically, as shown in FIG. 2, the plurality of driving decoupling structures 32 are distributed in the first direction X, the first mass blocks 11 are located between adjacent driving decoupling structures 32, the second mass blocks 21 are located between adjacent driving decoupling structures 32, and the first mass blocks 11 and the second mass blocks 21 are connected through the coupling beams 33 and the driving decoupling structures 32.

In this embodiment, as shown in FIG. 2, the driving decoupling structures 32 comprise first driving decoupling structures 321, second driving decoupling structures 322 and third driving decoupling structures 323 distributed in the first direction X. The first moving components 1 are located between the first driving decoupling structures 321 and the second driving decoupling structures 322, and the second moving components 2 are located between the second driving decoupling structures 322 and the third driving decoupling structures 323. The first mass blocks 11 and the second mass blocks 21 are connected through the coupling beams 33 and the second driving decoupling structures 322. When the dual-axis gyroscope is in the driving mode, the first driving decoupling structures 321, the second driving decoupling structures 322 and the third driving decoupling structures 323 all move in the second direction Y, moving directions of the first driving decoupling structures 321 and the third driving decoupling structures 323 are the same, moving directions of the first driving decoupling structures 321 and the second driving decoupling structures 322 are opposite, and moving directions of the third driving decoupling structures 323 and the second driving decoupling structures 322 are opposite, so as to drive the first mass blocks 11 and the second mass blocks 21 to swing in opposite directions.

As shown in FIG. 2, at least part of the coupling beam 33 is a deformable structure, and at least part of the coupling beam 33 is elastically deformable when the first mass block 11 swings around the first central axis and the second mass block 21 swings around the second central axis.

In this embodiment, the first mass blocks 11 are connected with the first driving decoupling structures 321 and the second driving decoupling structures 322 through the coupling beams 33, and the second mass blocks 21 are connected with the second driving decoupling structures 322 and the third driving decoupling structures 323 through the coupling beams 33. The coupling beams 33 have high rigidity in the first plane and can be elastically deformed in a plane outside the first plane. That is, when the dual-axis gyroscope is in the driving mode, the driving parts 31 can drive the first mass blocks 11 and the second mass blocks 21 to rotate through the motion of the driving decoupling structures 32 and the coupling beams 33 in the second direction Y. Because the coupling beams 33 have high rigidity in the first plane, the accuracy of controlling the motion states of the first mass blocks 11 and the second mass blocks 21 by the driving parts 31 is improved. When the dual-axis gyroscope is in the detection mode, as shown in FIGS. 4 and 5, the first mass blocks 11 or the second mass blocks 21 rotate out of the first plane, and at this point, the coupling beams 33 can be elastically deformed, thus reducing the influence of the coupling beams 33 on the motion states of the first mass blocks 11 and the second mass blocks 21, and improving the stability and accuracy of the motion states of the first mass blocks 11 and the second mass blocks 21 outside the first plane. At the same time, the first mass blocks 11 and the second mass blocks 21 are connected with the driving decoupling structures 32 through the coupling beams 33, so the elastic deformation of the coupling beams 33 when the dual-axis gyroscope is in the detection mode reduces the risk of movement of the driving decoupling structures 32 driven by the first mass blocks 11 or the second mass blocks 21, thereby decoupling the motion of the first mass blocks 11 and the motion of the driving decoupling structures 32, as well as the motion of the second mass blocks 21 and the motion of the driving decoupling structures 32, and enhancing the operational stability of the dual-axis gyroscope.

As shown in FIG. 2, a plurality of first anchor points 12 are provided in the second direction Y, and one first mass block 11 is connected with one first anchor point 12. Similarly, a plurality of second anchor points 22 are provided in the second direction Y, and one second mass block 21 is connected with one second anchor point 22. In the second direction Y, the coupling beams 33 are connected with the first mass blocks 11 at two ends, and the coupling beams 33 are connected with the second mass blocks 21 at two ends, so as to simplify the connection between the coupling beams 33 and the first mass blocks 11, as well as the connection between the coupling beams 33 and the second mass blocks 21.

In any of the above embodiments, the driving parts 31 are mounted on the driving decoupling structures 32, and the plurality of driving parts 31 are distributed at intervals in an extension direction of the driving decoupling structures 32.

In any one of the above embodiments, as shown in FIG. 2, the driving unit 3 further comprises driving beams 34, the driving decoupling structures 32 are connected with fourth anchor points 5 through the driving beams 34, and a plurality of driving beams 34 and a plurality of fourth anchor points 5 are provided in the second direction Y.

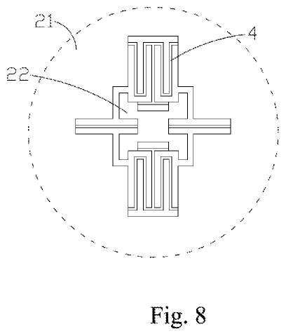

In any one of the above embodiments, as shown in FIGS. 2 and 8, the dual-axis gyroscope further comprises torsion beams 4, the first mass blocks 11 and the first anchor points 12 are connected through the torsion beams 4, and the second mass blocks 21 and the second anchor points 22 are connected through the torsion beams 4. The first mass blocks 11 and the first anchor points 12 are connected through first torsion beams, and the second mass blocks 21 and the second anchor points 22 are connected through second torsion beams.

In this embodiment, when the dual-axis gyroscope is in the first detection mode, the first mass blocks 11 rotate and the second torsion beams do not move, thus preventing relative movement between the second mass blocks 21 and the second anchor points 22. Similarly, when the dual-axis gyroscope is in the second detection mode, the second mass blocks 21 rotate and the first torsion beams do not move, thus preventing relative movement between the first mass blocks 11 and the first anchor points 12. This effectively reduces the mutual influence of the motion states of the first mass blocks 11 and the second mass blocks 21, thereby reducing the cross-coupling of the first mass blocks 11 and the second mass blocks 21 and improving the operational stability and signal-to-noise ratio of the dual-axis gyroscope.

In any one of the above embodiments, the detecting unit comprises a differential detection structure, and the first mass blocks 11 and the second mass blocks 21 perform differential detection through the differential detection structure, thereby reducing the interference of external electrical and mechanical noise, and further improving the signal-to-noise ratio of the dual-axis gyroscope.

The differential detection structure comprises a differential capacitor and/or a differential inductor.

In this embodiment, the implementation of the differential detection structure includes, but is not limited to, the capacitor structure and the inductor structure, and the specific implementation of the differential detection structure is not particularly limited in this application, so as to increase the structural flexibility of the differential detection structure and further expand the application scope of the differential detection structure.

A second aspect of the embodiments of the present invention provides an electronic product, which comprises a body and the dual-axis gyroscope in any one of the above embodiments, and the dual-axis gyroscope is mounted on the body.

During the operation of the electronic product, the dual-axis gyroscope can calculate the angular rates of the electronic product rotating around the first direction X and the second direction Y, which enables control over the electronic product. The tightly coupled connections between the first mass blocks 11 and the tightly coupled connections between the second mass blocks 21 of the dual-axis gyroscope reduce rotation angle errors between the first mass blocks 11 and rotation angle errors between the second mass blocks 21 during operation, thereby improving the accuracy of displacement ratios of the first mass blocks 11 and the second mass blocks 21, and enhancing the operational accuracy and stability of the dual-axis gyroscope, and as a result, the operational stability of the electronic device is improved. Additionally, as the tightly coupled connections improve the accuracy of displacement ratios of the first mass blocks 11 and the second mass blocks 21, the requirement for the machining precision of the first mass blocks 11 and the second mass blocks 21 is reduced, thus lowering the manufacturing cost of the dual-axis gyroscope and the electronic device. Further, in the detection mode of the dual-axis gyroscope, the motion of the first mass blocks 11 and the motion of the second mass blocks 21 is decoupled. That is, in a first detection mode, the first mass blocks 11 swing, while there is no relative motion between the second mass blocks 21 and the second anchor points 22. In a second detection mode, the second mass blocks 21 swing, while there is no relative motion between the first mass blocks 11 and the first anchor points 12. As a result, the cross-interference between angular rates in the first direction X and the second direction Y is reduced, minimizing the impact of orthogonal errors and improving the signal-to-noise ratio of a device.

The above are only embodiments of the present invention. It should be pointed out here that for those of ordinary skill in the art, improvements can be made without departing from the inventive concept of the present invention, and all these improvements should fall within the protection scope of the present invention.

What is claimed is:

1. A dual-axis gyroscope, comprising:
first mass blocks (11) each capable of swinging around a first anchor point (12) in a first plane and swinging around a first central axis of the first anchor point (12);
second mass blocks (21) each capable of swinging around a second anchor point (22) in the first plane and swinging around a second central axis of the second anchor point (22);
wherein a plane defined by a length direction and a width direction of the dual-axis gyroscope is the first plane, the first central axis and the second central axis are both located in the first plane, and one of the first central axis and the second central axis is parallel to the length direction of the dual-axis gyroscope and the other is parallel to the width direction of the dual-axis gyroscope;
the first mass blocks (11) and the second mass blocks (21) are distributed in a first direction (X), the plurality of first mass blocks (11) are distributed in a second direction (Y), swing directions of adjacent first mass blocks (11) are opposite, the plurality of second mass blocks (21) are distributed in the second direction (Y), swing directions of adjacent second mass blocks (21) are opposite, and one of the first direction (X) and the second direction (Y) is the length direction of the dual-axis gyroscope and the other is the width direction of the dual-axis gyroscope; and
tightly coupled connections are formed between adjacent first mass blocks (11) through first coupling rods (13), and tightly coupled connections are formed between adjacent second mass blocks (21) through second coupling rods (23);
a driving unit (3) connected with the first mass blocks (11) and the second mass blocks (21) to drive the first mass blocks (11) and the second mass blocks (21) to swing in the first plane; and
a detecting unit capable of detecting a swing angle of the first mass block (11) around the first central axis and a swing angle of the second mass block (21) around the second central axis.

2. The dual-axis gyroscope according to claim 1, wherein the first coupling rod (13) comprises a first connecting portion (131), a second connecting portion (132) and a third connecting portion (133), and the first connecting portion (131) and the second connecting portion (132) are oppositely arranged on two sides of the third connecting portion (133) in the first direction (X); and at least part of the first connecting portion (131) and at least part of the second connecting portion (132) extend in the second direction (Y), and the first connecting portion (131) and the second connecting portion (132) are connected to adjacent first mass blocks (11).

3. The dual-axis gyroscope according to claim 1, wherein the second coupling rod (23) comprises a fourth connecting portion (231), a fifth connecting portion (232) and a sixth connecting portion (233), and the fourth connecting portion (231) and the fifth connecting portion (232) are oppositely arranged on two sides of the sixth connecting portion (233) in the first direction (X); and at least part of the fourth connecting portion (231) and at least part of the fifth connecting portion (232) extend in the second direction (Y), and the fourth connecting portion (231) and the fifth connecting portion (232) are connected to adjacent second mass blocks (21).

4. The dual-axis gyroscope according to claim 1, wherein the driving unit (3) comprises driving parts (31), driving decoupling structures (32) and coupling beams (33), the driving parts (31) are fixedly connected with the driving decoupling structures (32), the driving decoupling structures (32) and the first mass blocks (11) are connected through the coupling beams (33), and the driving decoupling structures (32) and the second mass blocks (21) are connected through the coupling beams (33); and the driving parts (31) are capable of driving the driving decoupling structures (32) to move in the second direction (Y) to drive the first mass blocks (11) and the second mass blocks (21) to swing in the first plane.

5. The dual-axis gyroscope according to claim 4, wherein the plurality of driving decoupling structures (32) are distributed in the first direction (X), the first mass blocks (11) are located between adjacent driving decoupling structures (32), the second mass blocks (21) are located between adjacent driving decoupling structures (32), and the first mass blocks (11) and the second mass blocks (21) are connected through the coupling beams (33) and the driving decoupling structures (32).

6. The dual-axis gyroscope according to claim 4, wherein the driving part (31) comprises a capacitive driving structure and/or an inductive driving structure.

7. The dual-axis gyroscope according to claim 4, wherein at least part of the coupling beam (33) is a deformable structure, and at least part of the coupling beam (33) is elastically deformable when the first mass block (11) swings around the first central axis and the second mass block (21) swings around the second central axis.

8. The dual-axis gyroscope according to claim 1, wherein the dual-axis gyroscope further comprises torsion beams (4), the first mass blocks (11) and the first anchor points (12) are connected through the torsion beams (4), and the second mass blocks (21) and the second anchor points (22) are connected through the torsion beams (4); and
when the first mass block (11) and the second mass block (21) swing, at least part of the torsion beam (4) is elastically deformable.

9. The dual-axis gyroscope according to claim 1, wherein the detecting unit comprises a differential detection structure, and the differential detection structure comprises a differential capacitor and/or a differential inductor.

10. An electronic product, comprising:
a body; and
the dual-axis gyroscope according to claim 1, wherein the dual-axis gyroscope is mounted on the body.
